(19) United States
(12) Patent Application Publication
(10) Pub. No.: US 2005/0002394 A1
(43) Pub. Date: Jan. 6, 2005

(54) Method for analysing the operation of a packet data transmission network interface

(75) Inventors: Pierre Eisenmann, Paris (FR); Nidham Ben Rached, Paris (FR); Bruno Baynat, Paris (FR)

Correspondence Address: PIPER RUDNICK, P. O. BOX 64807, CHICAGO, IL, 60664-0807, US

(73) Assignee: NORTEL NETWORKS LIMITED

(21) Appl. No.: 10/869,612

(22) Filed: Jun. 14, 2004

(30) Foreign Application Priority Data
Jun. 12, 2003 (FR) 03 07072

(51) Int. Cl. H04L 12/56

(52) U.S. Cl. 370/389; 370/498

(57) ABSTRACT

The invention aims to analyse the operation of an interface of a packet data transmission network comprising terminals capable of exchanging data in packets with at least one entity of the network via at least one base station over the said network interface. For a set of integers n, the probability S(n) that a number n of terminals exchange data with at least one base station during an elementary transmission time interval is estimated.

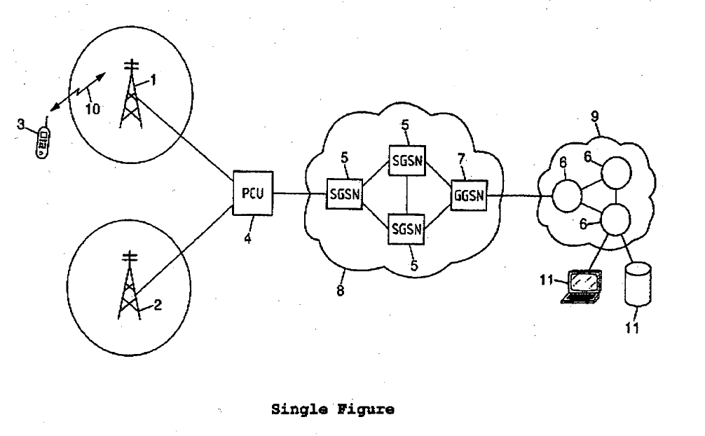

### BACKGROUND OF THE INVENTION

The present invention relates to the characterization of an interface of a packet data transmission network. More specifically, it relates to the possibility of acquiring and exploiting relevant information relating to the traffic flowing through this interface.

In voice transmission networks, such as a PSTN (Public Switched Telephone Network), it has been known for a long time to use the Erlang Laws to define a blocking probability in terms of the mean duration of calls, the mean period between calls and the number of resources in the system. These laws serve as a basis for dimensioning voice traffic networks, making it possible to deduce the number of resources to be provided in the network for allowing a certain traffic with a predetermined blocking probability. In Erlang modelling, the voice traffic follows an exponential, or Poisson, probability law, which gives it a relatively low level of complexity and therefore makes it easy to use.

In packet data transmission networks, such as for example certain wireless data networks, an Erlang-type characterization is unsuitable since further parameters also have to be taken into account, such as the data transmission rate, which is a particularly relevant item of information regarding the performance of such networks.

Hitherto, the analysis of packet data transmission networks and the applications that result therefrom, such as supervision or dimensioning, are faced with the problem of the lack of simple modelling, which makes them either too expensive in terms of time and in computing capacity, or too approximate and therefore not very satisfactory.

It is an object of the present invention to fill this lack, by proposing another type of analysis of relatively low complexity of the traffic-limiting interface in a packet data transmission network.

It is another object of the invention to obtain, in an easy manner, relevant performance indicators for such a network interface.

### SUMMARY OF THE INVENTION

Yet another object of the invention is to exploit the information obtained by analysis of the interface, in order to supervise, optimize or dimension this interface.

The invention thus proposes a method for analysing the operation of an interface of a packet data transmission network comprising terminals capable of exchanging data in packets with at least one entity of the network via at least one base station over the said network interface. According to this method, for a set of integers n, the probability S(n) that a number n of terminals exchange data with at least one base station during an elementary transmission time interval is estimated.

In one advantageous embodiment, the data exchanges over the said interface include successive periods of downloading and periods of silence, each download containing a quantity of data exchanged over the said network interface with a geometric distribution, and the periods of silence having a duration with a geometric distribution. Each probability S(n) is calculated using a memoryless Markov process.

Such a calculation of the probability S(n) which may be repeated at successive instants, thus makes it possible to obtain a quantity that characterizes the interface in question and from which may be deduced various relevant items of information about the operation of the interface, such as performance indicators, for example a distribution of data rates relating to the data exchanges, a blocking probability, or a data-exchange resource utilization distribution.

The performance indicators thus obtained may be exploited in order to supervise the operation of the interface, in order to improve the performance of this interface by taking the value of the indicators, especially in the mechanism for allocatng the resources over the interface, into account or else to dimension the said interface so as to obtain satisfactory values for certain performance indicators.

The interface in question may advantageously be a radio interface, for example of the GPRS (“General Packet Radio Service”), EDGE (“Enhanced Data rates for GSM Evolution”) or UMTS (“Universal Mobile Tele-communication System” in packet mode type. The data exchanges that pass through this interface may be uplink transfers (from terminals to a base station) or, advantageously, downlink transfers (from a base station to terminals).

The invention also proposes a packet control unit on an interface of a packet data transmission network comprising terminals capable of exchanging data in packets with at least one entity of the network via at least one base station over the said network interface. This packet control unit comprises means for estimating, for a set of integers n, the probability S(n) that a number n of terminals exchange data with at least one base station during an elementary transmission time interval.

Such a packet control unit thus allows the abovementioned method to be implemented by means of a statistical estimate of the probability S(n), over at least one significant observation time period.

### BRIEF DESCRIPTION OF THE DRAWING

The single FIGURE is a block diagram of a packet data transmission network capable of implementing the invention.

### DESCRIPTION OF PREFERRED EMBODIMENTS

The present invention is applicable in any packet data transmission network having a limiting interface in terms of traffic flow. This is the case, for example, in certain radio communication networks or wireless networks, in which the radio interface is the most subject to variations in the data transfer. The other interfaces involved, such as for example the interfaces used in the core network of such networks or even in external data networks interconnected to the wireless networks, may be considered as already being optimized and as having only a relatively minor impact on the service conditions compared with the said radio interface.

As examples, networks supporting the following protocols: GPRS (“General Packet Radio Service”), EDGE (“Enhanced Data for GSM Evolution”) or UMTS (“Universal Mobile Telecommunication System”) in packet mode may be analysed in terms of operation of the corresponding radio interface according to the present invention.

The resources over the radio interface of these networks are generally managed by a specific allocator for a set of terminals. In GPRS technology, this allocator lies in a unit called a PCU (Packet Control Unit) 4, as illustrated in the FIGURE. This packet control unit controls in particular the allocation of the resources between the terminals 3 that wish to exchange data with the network, via at least one base station 1-2 over the radio interface 10. Using the algorithms that it employs, a fixed or varying number of resources may be reserved to the packet data transmission service and shared between various terminals.

It will be considered hereafter that each terminal 3 connected with a base station 1 of the network alternates periods of downloading (ON periods) and periods of silence (OFF periods). During the downloading periods, it exchanges data with an entity 11 (for example a terminal or a server) of the network 9 via the base station 1, it being possible for these exchanges to be uplink transfers (data sent from the terminal to the base station) or else downlink transfers (data sent from the base station to the terminal). In the example illustrated in the FIGURE, the transfer of data between the terminal 3 and the entity 11 takes place via elements of the GPRS network, in particular the PCU 4 and certain SGSN (Serving GPRS Support Node) switches 5 or GGSN (Gateway GPRS Support Node) switches 6 of the core network 8, and also switches 6 of the external data network 9.

It will be considered hereafter, without however limiting the generality of the text, that the downloading transfers taking place over the radio interface are downlink transfers. This is the most representative case since the downlink traffic is usually more abundant than the uplink traffic. The downloaded data consists of data packets transmitted over the radio interface as transmission units corresponding to successive elementary time intervals, denoted by t_{B}. In the case of a GPRS network for example, the data transfer unit is a block, consisting of four bursts, the elementary duration of which is t_{B}=20 ms.

As regards the periods of silence, these correspond to time slots when no transmission takes place between the terminal and the base station, for example because the user of the terminal is in the process of reading the information that he has downloaded beforehand.

A series of alternating periods of downloading and periods of silence constitutes a data transmission session. Successive sessions may take place for a given terminal. The duration between the sessions could be modelled, for example using an exponential law. Without restricting the generality of the invention, we will, however, consider below the simplified case of infinite sessions, i.e. uninterrupted successions of ON and OFF periods for each terminal in question.

In an advantageous mode of implementation of the invention, it is considered that the quantity of data transmitted during the ON periods follows a geometric distribution, the mean of which is denoted by xₒₙ. Likewise, the duration of the OFF periods follows a geometric distribution, the mean of which is denoted by t_{off}.

Although different services may be used for certain terminals, it may be assumed that the data exchanged over the radio interface corresponds to a single type of service, for example the downloading of Web pages.

Moreover, the assumptions may be further simplified, without thereby limiting the generality of the invention, by assuming that the terminals all have the same traffic capacity, that is to say that they use the same number of resources shared within the ON periods when there is no contention. Likewise, in the ON period, the network allocates to each terminal an equivalent bandwidth, that is to say the same number of shared resources. These assumptions are of course made within the limits permitted by the system used, especially the maximum number of resources that can be assigned simultaneously to a terminal and the maximum number of terminals that these resources can share simultaneously.

The radio interface 10 in question is described using a memoryless Markov process. The “n” state of this system is therefore that when n terminals linked with a base station of the network are in an ON period, during the elementary time period t_{B} over which the observation is made. The state of the system in fact does not vary over an elementary transmission time interval. However, it is liable to vary between two successive elementary intervals t_{B}, for example because a terminal is entering a new ON period (the state then passes to the “n+1” state) or else because a terminal is entering an OFF period (the state then passes to the “n−1” state). If no ON or OFF period starts between the two successive elementary time intervals, the state then remains in the “n” state. In this representation, a single event may occur between successive instants, so that no transition other than those indicated above is possible.

Each transition in this system has a certain probability of occurrence. Let aᵢⁿ be the probability of having a number i of “arrivals” between two elementary time intervals, that is to say the start of i ON periods, while the state is the “n” state, and let dⱼⁿ be the probability of having a number j of “departures” between two elementary time intervals, i.e. the start of j OFF periods, when the state is in the “n” state, it being possible by assumption for i and j to be able to take only the values 0 or 1. The probability of passing from the “n” state to the “n+1” state during the next elementary time interval can then be written as: p_{n,n+1}=a₁ⁿd₀ⁿ, the probability of passing from the “n” state to the “n−1” state during the next elementary time interval may be written as: p_{n,n-1}=a₀ⁿd₁ⁿ, and the probability of remaining in the “n” state during the next elementary time interval may be written as: p_{n,n}=1−p_{n,n-1}−p_{n,n+1}.

Consequently, it may be demonstrated the probability S(n) of being in the “n” state may be written as:

$$S ( n ) = {\prod }_{i = 1}^{n} \frac{{a}_{1}^{i - 1} {d}_{0}^{i - 1}}{{a}_{0}^{i} {d}_{1}^{i}} \cdot S ( 0 )$$

$$\text{with:}$$

$$S ( 0 ) = \frac{1}{1 + {\sum }_{i = 1}^{n max} [ {\prod }_{i = 1}^{n} \frac{{a}_{1}^{i - 1} {d}_{0}^{i - 1}}{{a}_{0}^{i} {d}_{1}^{i}} ]} ,$$

where nₘₐₓ represents the maximum number of terminals in the system.

The probability S(n) may be determined repeatedly as successive observation instants, for example periodically, so as to construct a vector S of values S(n).

According to a variant of the invention, the number of resources that can be used for the data exchanges between the terminals and the base stations of the network varies over the course of time. In this case, a matrix is constructed, which groups together the probabilities S(n,r) of being in the “n” state of the system when r resources are available for exchanging data in packets.

The expression for S(n) may be simplified in order to reduce the complexity thereof. Since the duration of the OFF periods follows a geometric distribution, the following equation therefore obtains:

$${\sum }_{n = 1}^{∞} {n ( 1 - q )}^{n - 1} q = 1 / q ,$$

where 1/q represents the normalized mean of the geometric distribution, i.e.

$$q = \frac{1}{⌈ \frac{{t}_{off}}{{t}_{B}} ⌉}$$

using the previously adopted notations. Likewise, the size of the exchanged data during the ON periods also follows a geometric distribution with 1/p as the normalized mean, where

$$p = \frac{1}{⌈ \frac{{x}_{on}}{{x}_{B}} ⌉} ,$$

with x_{B} representing the size of the data transferred during an elementary time interval t_{B} and ┌z┐ representing the integer equal to or immediately higher than z.

Let us consider a system comprising terminals that share the available resources in an equitable manner at a given instant, among a maximum number nₘₐₓ of terminals in the system. The bandwidth b(n) assigned to each terminal depends on the number n of terminals in the ON period. For example, if the system makes available to the terminals a maximum number T of resources for data exchange and if each terminal in the ON period uses a number d of resources simultaneously, the number of resources used in the system is equal to the product of n multiplied by d, provided that this number does not exceed T. Let n₀ be the number of terminals in the ON period such that n₀.d is equal to T. If n is greater than n₀ (while still being less than nₘₐₓ), the T resources of the system are used.

Let p(n) be the probability that the current elementary time interval is the last one of an ON period for a terminal of the system as defined above. This probability may be written as:

$$p ( n ) = p \cdot \frac{b ( n )}{[ \frac{{x}_{B}}{{t}_{B}} ]} .$$

According to the definition of b(n) given above, it may be concluded that, when T is greater than d, p(n)=p.d if n is greater than or equal to n₀, and

$$p ( n ) = p \cdot \frac{T}{n}$$

otherwise. When T is less than d, p(n) may be expressed as:

$$p ( n ) = p \cdot min ( d , \frac{T}{n} ) .$$

The parameters aᵢⁿ and dⱼⁿ defined above may therefore be expressed as a function of these probabilities q and p(n). If N is the number of terminals present at a given instant in the system under study, it may be demonstrated that a₀ⁿ=(1−q)^{N-n}. This means that the probability of having no arrival in the system (i.e. no start of an ON period), while in the “n” state, corresponds to the probability that no OFF period is completed for the N−n terminals not exchanging data with the network at the current instant. Furthermore: a₁ⁿ=1−a₀ⁿ. Assuming that q is very much less than 1, which is so in the general case, these expressions many then be simplified so that: a₀ⁿ≈1−(N−n)·q and a₁ⁿ≈(N−n)·q. Likewise: d₀ⁿ=(1−p(n))ⁿ and d₁ⁿ=1−d₀ⁿ; i.e. assuming that p(n) is very much less than 1, d₀ⁿ=1−n.p (n) and d₁ⁿ=n.p (n).

It may therefore be demonstrated that the probability S(n) is given by the following simplified formula when the parameters a₁ⁿ and dⱼⁿ are replaced with the approximations given in the previous paragraph:

$$S ( n ) = {\prod }_{i - 1}^{n} \frac{[ N - ( i - l ) ] \cdot q \cdot [ 1 - p \cdot min ( ( i - 1 ) \cdot d , T ) ]}{[ 1 - ( N - i ) \cdot q ] \cdot p \cdot min ( i \cdot d , T )} \cdot S ( 0 ) , \\ where$$

$$S ( 0 ) = \frac{1}{1 + {\sum }_{i = 1}^{n max} {\prod }_{i = 1}^{n} \frac{[ N - ( i - 1 ) ] \cdot q \cdot [ 1 - p \cdot min ( ( i - 1 ) \cdot d , T ) ]}{[ 1 - ( N - i ) \cdot q ] \cdot p \cdot min ( i \cdot d , T )}} ,$$

This formulation of S(n) is in accordance with the objectives set, since it has a relatively low level of complexity, substantially equivalent to that of the Erlang Law mentioned in the introduction.

S(n) may be further simplified by assuming that the quantities N.P and N.q are very much less than 1. In this case, it may be demonstrated that:

$$S ( n ) = [ {\sum }_{i = 1}^{n} \frac{( N - ( i - 1 ) ) q}{min ( id , T ) p} ] S ( 0 ) = \frac{N ( N - 1 ) … ( N - ( n - 1 ) )}{n ! {d}^{n}} {( \frac{q}{p} )}^{n} S ( 0 ) , \\ when n \leq {n}_{0} and$$

$$S ( n ) = [ {\sum }_{i = 1}^{n} \frac{( N - ( i - 1 ) ) q}{min ( id , T ) p} ] S ( 0 ) = \frac{N ( N - 1 ) … ( N - ( n - 1 ) )}{{n}_{0} ! {d}^{{n}_{0}} {T}^{n - {n}_{0}}} {( \frac{q}{p} )}^{n} S ( 0 ) , \\ when n > {n}_{0}$$

which means that S(n) may also be written as:

$$S ( n ) = \frac{N !}{n ! {d}^{n} ( N - n ) !} {( \frac{q}{p} )}^{n} S ( 0 ) , when n \leq {n}_{0} and$$

$$S ( n ) = \frac{N !}{{n}_{0} ! {d}^{{n}_{0}} {T}^{n - {n}_{0}} ( N - n ) !} {( \frac{q}{p} )}^{n} S ( 0 ) , when n > {n}_{0} with$$

$$S ( 0 ) = \frac{1}{\begin{matrix}1 + [ {\sum }_{n = 1}^{{n}_{0}} \frac{N !}{n ! {d}^{n} ( N - n ) !} {( \frac{q}{p} )}^{n} + \\ {\sum }_{n = {n}_{0} + 1}^{{n}_{max}} \frac{N !}{{n}_{0} ! {d}^{{n}_{0} {T}^{n - {n}_{0}}} ( N - n ) !} {( \frac{q}{p} )}^{n} ]\end{matrix}} . \qquad ( 3 )$$

The complexity of these expressions is thus considerably reduced.

As indicated above, the probabilities S(n) calculated at various instants of observation thus make it possible to obtain a source of particularly useful information about the behaviour of the radio interface of the network in question in terms of traffic.

The probabilities S(n) may be determined on the basis of traffic assumptions. For example, the parameters aᵢⁿ and dⱼⁿ or the parameters p and q may be derived from simulations, so that the estimate of S(n) is made quite directly.

According to another mode of implementation, the estimate of S(n) arises only from observations made on the interface in question. In this case, the PCU 4 in question will advantageously count, over periods of observation that are long enough to obtain significant statistics, the integer number x(n) of elementary transmission time intervals t_{B} during which a number n of terminals 3 exchange data with at least one base station 1 or 2. The probability S(n), for integer n, is then calculated by the PCU 4, for example using the expression:

$$S ( n ) = \frac{x ( n )}{{\sum }_{i - 0}^{{n}_{max}} x ( i )} ,$$

where nₘₐₓ represents the maximum number of terminals in the system in question, or using any other method for estimating the mean value of the proportion of time spent in the “n” state.

Advantageously, a subsequent step may be implemented, after the S(n) values have been estimated, in order to take advantage of relevant performance indicators for the interface in question. This is because many characteristic indicators of the radio interface and of its behaviour in terms of traffic may be deduced from the vector (or from the matrix) S.

Among these performance indicators, mention may for example be made of a distribution of the data rate of data transmissions over the radio interface, the data rate being dependent on the resources used or available in the system. The vector S(n) is in fact used to determine the probability with which each data rate is achieved. A mean data rate may also be readily calculated by averaging the data rates of the distribution obtained. The data rate offered in the worst case may also be obtained, by observing or estimating the data rate offered in the case in which n=nₘₐₓ, i.e. when the total capacity of the system is used. The probability of being in this worst case corresponds in fact to the value S(nₘₐₓ).

The complete distribution and therefore the percentiles may also be obtained for the data rate or for the occupancy of the radio resources, noting that it is possible to obtain all the moments of the distribution. The complete distribution may be obtained by an inverse Laplace transform. This is due to the fact that the probability of being in each state is known, and the moment of order k is therefore the mean of the quantity raised to the power k weighted by the probability of being in each state. For example, it may be noted that, for the data rate distribution, it is necessary to eliminate the 0 state from the distribution for which the data rate is not defined using the formula

$${\sum }_{i - 1}^{{i}_{0}} \tilde{ S} ( {n}_{max} - i ) \leq k ,$$

where i₀ is the highest integer for which such a formula is satisfied and \tilde{S} is a normalization of S by

$${S}_{norm} {\sum }_{n = 1}^{{n}_{max}} S ( n ) ,$$

i.e.

$$\tilde{S} = \frac{S}{{S}_{norm}} .$$

Another useful performance indicator is the blocking probability over the radio interface in question. The blocking probability corresponds in fact to the probability that a demand for resources is rejected by the network, because all the resources that can be allocated are already being used. The blocking probability may therefore be likened to the value S(nₘₐₓ).

Furthermore, the occupancy of the resources of the system depends directly on the number of terminals in the ON period. Thus, corresponding to each number n of terminals undergoing transfer in the system is a certain resource utilization, the probability of which is equal to S(n). Thus, it is possible to determine a resource utilization distribution.

All these performance indicators may be deduced from the vector S, for example by computation in the PCU 4 in question. Of course, many other indicators may also be calculated in order to obtain other items of information that characterize the operation of the radio interface in question. These indicators may be exploited in order, for example, to generate alarms in the system, the alarms being activated in the light of a comparison between a combination of certain indicators and thresholds. Furthermore, the knowledge of performance characteristics may be reintroduced into the system in order to improve certain decisions: for example, the resource allocation may be different depending on the blocking probability or the mean data rate observed in the system. If the system possesses a variable number of resources for the flow of data traffic, this may for example be increased if the performance characteristics revealed by the indicators obtained are not sufficiently satisfactory.

In another mode of implementation, the vector (or the matrix) S may serve as a basis for dimensioning the system. To do this, it is possible for example to measure the traffic exchanged in the system using known means (especially the acquisition of traces). Assumptions are then made about the number of resources and the number of terminals that can exchange data with the network. The vector S is then constructed. Performance indicators such as those mentioned above are calculated from this vector. The configuration that gives rise to the most satisfactory performance characteristics among the various assumptions envisaged is then selected.

1. Method for analysing the operation of an interface of a packet data transmission network comprising terminals capable of exchanging data in packets with at least one entity of the network via at least one base station over the said network interface, wherein, for a set of integers n, the probability S(n) that a number n of terminals exchange data with at least one base station during an elementary transmission time interval is estimated.

2. Method according to claim 1, in which the data exchanges over the said interface include successive periods of downloading and periods of silence, each download containing a quantity of data exchanged over the said network interface with a geometric distribution, and the periods of silence having a duration with a geometric distribution, and in which method each probability S(n) is calculated using a memoryless Markov process.

3. Method according to claim 2, in which each probability S(n) is calculated according to the expression:
$$S ( n ) = {\prod }_{i = 1}^{n} \frac{{a}_{1}^{i - 1} {d}_{0}^{i - 1}}{{a}_{0}^{i} {d}_{1}^{i}} \cdot S ( 0 ) ,$$
where S(0) is of the form:
$$S ( 0 ) = \frac{1}{1 + {\sum }_{i = 1}^{n max} [ {\prod }_{i = 1}^{n} \frac{{a}_{1}^{i - 1} {d}_{0}^{i - 1}}{{a}_{0}^{i} {d}_{1}^{i}} ]} ,$$
a₁ⁱ and d₁ⁱ representing, for integer i, the probability of a period of downloading and a period of silence, respectively, starting between two successive elementary transmission time intervals when i terminals exchange data with the said base station, a₀ⁱ and d₀ⁱ representing the probability of there being no start of a period of downloading and a period of silence, respectively, between two successive elementary transmission time intervals when i terminals exchange data with the said base station, and nₘₐₓ representing a maximum number of terminals.

4. Method according to claim 2, in which each probability S(n) is calculated according to the expression:
$$S ( n ) = {\prod }_{i = 1}^{n} \frac{[ N - ( i - 1 ) ] \cdot q \cdot [ 1 - p \cdot min ( ( i - 1 ) \cdot d , T ) ]}{[ 1 - ( N - i ) \cdot q ] \cdot p \cdot min ( i \cdot d , T )} \cdot S ( 0 ) ,$$
where S(0) is of the form:
$$S ( 0 ) = \frac{1}{1 + {\sum }_{i = 1}^{nmax} {\prod }_{l = 1}^{n} \frac{[ N - ( i - 1 ) ] \cdot q \cdot [ 1 - p \cdot min ( ( i - 1 ) \cdot d , T ) ]}{[ 1 - ( N - i ) \cdot q ] \cdot p \cdot min ( i \cdot d , T )}}$$
N being a number of terminals that can exchange data with the said base station, nₘₐₓ representing a maximum number of terminals, q representing the probability that a period of silence is completed after the said elementary transmission time interval, p representing the probability that a period of downloading is completed after the said elementary transmission time interval, d representing a number of resources used by the terminals when they exchange data with the said base station, and T representing a maximum number of resources for the data exchanges between terminals and the said base station.

5. Method according to claim 2, in which each probability S(n) is calculated according to:
$$\begin{matrix}S ( n ) = \frac{N !}{n ! {d}^{n} ( N - n ) !} {( \frac{q}{n} )}^{n} S ( 0 ) , when n \leq {n}_{0} , \\ and S ( n ) = \frac{N !}{{n}_{0} ! {d}^{{n}_{0}} {T}^{n - {n}_{0}} ( N - n ) !} {( \frac{q}{n} )}^{n} S ( 0 ) , when n > {n}_{0} , where \\ S ( 0 ) = \frac{1}{1 + [ {\sum }_{n = 1}^{{n}_{0}} \frac{N !}{n ! {d}^{n} ( N - n ) !} {( \frac{q}{n} )}^{n} + {\sum }_{n = {n}_{0} + 1}^{{n}_{max}} \frac{N !}{{n}_{0} ! {d}^{{n}_{0}} {T}^{n - {n}_{0}} ( N - n ) !} {( \frac{q}{p} )}^{n} ]} ,\end{matrix}$$
N being a number of terminals that can exchange data with the said base station, nₘₐₓ representing a maximum number of terminals, q representing the probability that a period of silence is completed after the said elementary transmission time interval, p representing the probability that a period of downloading is completed after the said elementary transmission time interval, d representing a number of resources used by the terminals when they exchange data with the said base station, T represents a maximum number of resources for the data exchanges between terminals and the said base station and no representing a number of terminals exchanging data with the said base station whenever the said T resources are all being used.

6. Method according to claim 4, in which p may be written as
$$p = \frac{1}{⌈ \frac{{x}_{on}}{{x}_{B}} ⌉} ,$$
and q may be written as
$$q = \frac{1}{⌈ \frac{{t}_{off}}{{t}_{B}} ⌉} ,$$
where xₒₙ is a mean quantity of data exchanged between terminals and the said base station, x_{B} is a quantity of data transferred during an elementary transmission time interval t_{B}, and t_{off} is a mean duration of a period of silence.

7. Method according to claim 5, in which p may be written as
$$p = \frac{1}{⌈ \frac{{x}_{on}}{{x}_{B}} ⌉} ,$$
and q may be written as
$$q = \frac{1}{⌈ \frac{{t}_{off}}{{t}_{B}} ⌉} ,$$
where xₒₙ is a mean quantity of data exchanged between terminals and the said base station, x_{B} is a quantity of data transferred during an elementary transmission time interval t_{B}, and t_{off} is a mean duration of a period of silence.

8. Method according to claim 1, in which the data exchanges are carried out from the base station to at least certain of the said terminals.

9. Method according to claim 1, in which the said network interface is a radio interface.

10. Method according to claim 9, in which the said radio interface is of the GPRS (“General Packet Radio Service”), EDGE (“Enhanced Data rates for GSM Evolution”) or UMTS (“Universal Mobile Telecommunication System” in packet mode type.

11. Method according to claim 1, in which the probability S(n) is estimated repeatedly at successive instants.

12. Method according to claim 11, including a subsequent step of deducing performance indicators relating to the said network interface from the determined probabilities S(n).

13. Method according to claim 12, in which the performance indicators relating to the said network interface are at least certain from among: a distribution of data rates relating to the data exchanges, a distribution of blocking rates and a distribution of resource utilization for the data exchanges.

14. Method according claim 12, in which an exploitation of at least certain of the performance indicators is carried out.

15. Method according to claim 14, in which the exploitation of the performance indicators comprises combining at least certain of the said performance indicators and comparing the combined indicators with respective thresholds, in order to supervise the said network interface.

16. Method according to claim 14, in which the exploitation of the performance indicators comprises taking at least certain of the said performance indicators into account in a mechanism for allocating the resources to the said network interface.

17. Method according to claim 14, in which the exploitation of the performance indicators comprises taking at least certain of the said performance indicators into account in order to dimension the network interface, the dimensioning of the said network interface comprising a selection of assumptions from among various assumptions with regard to the number of resources for the data exchanges and the number of terminals that can exchange data with the network, on the basis of the performance indicators obtained for the various assumptions.

18. A packet control unit on an interface of a packet data transmission network comprising terminals capable of exchanging data in packets with at least one entity of the network via at least one base station over the said network interface, said packet control unit comprising means for estimating, for a set of integers n, the probability S(n) that a number n of terminals exchange data with at least one base station during an elementary transmission time interval.

19. Packet control unit according to claim 18, in which the means for estimating the probability S(n) comprise means for estimating a mean proportion of time during which a number n of terminals exchange data with at least one base station during an elementary transmission time interval.

20. Packet control unit according to claim 18, which furthermore includes means for counting, over at least one observation period, an integer number x(n) of elementary transmission time intervals during which n terminals exchange data with at least one base station, in which packet control unit the means for estimating the probability S(n) estimate the probability S(n) according to the expression:
$$S ( n ) = \frac{x ( n )}{{\sum }_{i = 0}^{{n}_{max}} x ( i )} ,$$
where nₘₐₓ denotes a maximum number of terminals.

21. Packet control unit according to claim 18, in which the means for estimating the probability S(n) comprise means for updating the probability S(n) at each new observation period.

22. Packet control unit according to claim 18, in which the said network interface is a radio interface.

23. Packet control unit according to claim 22, in which the said radio interface is of the GPRS (“General Packet Radio Service”), EDGE (“Enhanced Data rates for GSM Evolution”) or UMTS (“Universal Mobile Telecommunication Systems”)in packet mode type.

24. Packet control unit according to claim 18, comprising means for obtaining performance indicators relating to the said network interface from the probabilities S(n) that are estimated by the said means for estimating the probability S(n).

25. Packet control unit according to claim 24, in which the performance indicators relating to the said network interface are at least certain from among: a distribution of data rates relating to the data exchanges, a distribution of blocking rates and a distribution of resource utilization for the data exchanges.

26. Packet control unit according to claim 24, comprising means for allocating resources for the data exchanges between terminals and at least one base station, taking at least certain of the said performance indicators into account.
